(19) United States
(12) Patent Application Publication
(10) Pub. No.: US 2025/0002775 A1
(43) Pub. Date: Jan. 2, 2025

(54) METHOD TO USE LOSS CIRCULATION MATERIAL COMPOSITION COMPRISING ACIDIC NANOPARTICLE-BASED DISPERSION AND FORMATE BASED ACTIVATOR IN DOWNHOLE CONDITIONS

(71) Applicant: SAUDI ARABIAN OIL COMPANY, Dhahran (SA)

(72) Inventors: Vikrant Wagle, Dhahran (SA); Rajendra Arunkumar Kalgaonkar, Dhahran (SA); Abdullah Al-Yami, Dhahran (SA); Mohammad Alharthi, Dammam (SA)

(73) Assignee: SAUDI ARABIAN OIL COMPANY, Dhahran (SA)

(21) Appl. No.: 18/344,743

(22) Filed: Jun. 29, 2023

(51) Int. Cl. C09K 8/76

(52) U.S. Cl. CPC C09K 8/76; C09K 2208/10

(57) ABSTRACT

A loss circulation material includes an acidic nanosilica dispersion and a formate activator, which may be present in an amount in a range of 1 wt % to 40 wt % of the loss circulation material. A method to control lost circulation in a lost circulation zone in a wellbore includes introducing an acidic nanosilica dispersion into the wellbore, introducing a formate activator into the wellbore, contacting the acidic nanosilica dispersion with the formate activator, thereby forming a loss circulation material composition, and forming a gelled solid from the loss circulation material in the lost circulation zone. A method of controlling lost circulation in a lost circulation zone in a wellbore includes introducing a loss circulation material comprising an acidic nanosilica dispersion and a formate activator into the wellbore, such that they contact the lost circulation zone, and forming a gelled solid from the loss circulation material in the lost circulation zone.

### BACKGROUND

In wellbore drilling, a drilling fluid (or drilling mud) is circulated from a surface of the wellbore to downhole through the drill string. The fluid exits through ports (or jets) in the drill bit. The fluid picks up cuttings and carries the cuttings up an annulus formed between an inner wall of the wellbore and an outer wall of the drill string. The fluid and the cuttings flow through the annulus to the surface, where the cuttings are separated from the fluid. The fluid can be treated with chemicals and then pumped into the wellbore through the drill string to repeat the process.

During the drilling of subterranean wells, such as subterranean wells used in hydrocarbon development operations, the wellbore of the subterranean well can pass through a zone that has induced or natural fractures, are cavernous, or otherwise have an increased permeability compared with solid rock. Such a zone is known as a lost circulation zone. In such a case, the drilling mud and other fluids that are pumped into the well can flow into the lost circulation zone and become irretrievable. Thus, lost circulation is a situation in which the flow of the drilling fluid up the annulus toward the surface is reduced or is totally absent.

When unacceptable drilling fluid losses are encountered, lost circulation materials are introduced into the drilling fluid from the surface. The revised fluid that includes the lost circulation materials is pumped downhole as part of the standard well circulation system. The revised fluid passes through a circulation port to plug and pressure seal the exposed formation at the point where losses are occurring. Once sealing has occurred and acceptable fluid loss control is established, drilling operations can resume.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a loss circulation material that includes an acidic nanosilica dispersion and a formate activator. The formate activator may be present in an amount in a range of 1 wt % to 40 wt % of the loss circulation material.

In another aspect, embodiments herein a method to control lost circulation in a lost circulation zone in a wellbore. The method includes introducing an acidic nanosilica dispersion into the wellbore, introducing a formate activator into the wellbore, contacting the acidic nanosilica dispersion with the formate activator, thereby forming a loss circulation material composition, and forming a gelled solid from the loss circulation material in the lost circulation zone.

In another aspect, embodiments herein related to a method of controlling lost circulation in a lost circulation zone in a wellbore that includes introducing a loss circulation material comprising an acidic nanosilica dispersion and a formate activator into the wellbore, such that they contact the lost circulation zone, and forming a gelled solid from the loss circulation material in the lost circulation zone.

Other aspects and advantages of the claimed subject matter will be apparent from the following description and the appended claims.

### DETAILED DESCRIPTION

One or more embodiments in accordance with the present disclosure relate to loss circulation materials and methods to use such loss circulation materials (LCM) in downhole conditions. More specifically, embodiments herein are directed to loss circulation material compositions including gel forming compositions, and methods for producing a solid gel from the LCM. In particular, embodiments herein are directed toward a LCM composition including an acidic nanosilica dispersion and producing a solid gel based LCM by contacting the acidic nanosilica dispersion with a chemical activator.

In one or more embodiments, the loss circulation material composition includes an acidic nanosilica dispersion and the chemical activator includes a formate activator. The LCM of one or more embodiments utilizes network structures formed from the acidic nanosilica and formate activator to form a gelled material. The nanosilica gelling may be advantageously controlled by varying the relative concentration of the formate activator, allowing the gel to selectively form in the lost circulation zone. Additionally, such gels formed may be used at elevated temperatures and utilize environmentally friendly ingredients. Even further, it is theorized that use of such a LCM may be compatible with any suitable type of drilling fluid.

The formation of gels using the combination of nanosilica dispersions and activators according to embodiments herein may decrease loss of drilling fluids in any suitable type of lost circulation zone. As used throughout, “lost circulation zone” refers to an area encountered during drilling operations where the volume of drilling fluid returning to the surface is less than the volume of drilling fluid introduced to the wellbore. The lost circulation zone can be due to any kind of opening between the wellbore and the subterranean formation. Lost circulation zones that can be addressed by the solid gel based LCM from a convertible composition described herein can range from minor lost circulation or seepage loss to complete fluid loss.

For instance, minor lost circulation and seepage lost circulation is generally less than 10 barrels per hour (bbl/hr). However, minor lost circulation and seepage lost circulation can be greater or less than 10 bbl/hr depending on the base components of the drilling fluid and other suitable conditions. One of skill in the art would appreciate the various conditions that can define a minor or seepage lost circulation event.

“Moderate lost circulation” is a term for any lost circulation between seepage lost circulation and severe lost circulation and consists of any medium rate of lost circulation, for example, between 10 to 100 bbl/hr, 10 to 50 bbl/hr, or 10 to 30 bbl/hr.

“Severe lost circulation” is a term including any suitable high rate of lost circulation. Non-limiting examples of severe loss circulation include greater than 100 bbl/hr, greater than 50 bbl/hr, or greater than 30 bbl/hr.

### Loss Circulation Material Composition

In one aspect, embodiments herein are directed towards an LCM composition including an acidic nanosilica dispersion and a formate activator. The LCM composition including an acidic nanosilica dispersion and formate activator may form a solid or gelled solid upon contact. In some embodiments, the LCM composition may be configured to form a solid or a gelled solid upon contact in a reservoir. The LCM composition may form a gelled solid proximate to a loss circulation zone in a reservoir.

In one or more embodiments, the acidic nanosilica dispersion includes acidic silica nanoparticles. Acidic silica nanoparticles useful according to embodiments herein may include nanoparticles formed from a silica source, including sodium silicate and tetraethyl orthosilicate (TEOS). An example of a commercially available acidic nanosilica dispersion may include, but is not limited to, CS30-516 P, previously available from Akzo Nobel. Another non-limiting example of a commercially available acidic nanosilica dispersion may include Levasil® FX200 C, available from Nouryon. In some embodiments, the acidic nanosilica dispersion may include sodium silicate as well as acidic silica nanoparticles. In some embodiments, the acidic nanosilica dispersion does not include sodium silicate.

The acidic silica nanoparticles may have a silicon dioxide content (SiO₂) in range from 5 percent by weight (wt %) to 65 wt % based on the total weight of the dispersion. The greater the silicon dioxide content, the faster the rate of a gel will form. The acidic silica nanoparticles may be in a range with a lower limit of any one of 5, 10, 15, 20, 25, 30, 40, and 45 wt % and an upper limit of any one of 20, 25, 30, 35, 40, 45, 55, 60, and 65 wt %, where any lower limit may be paired with any mathematically compatible upper limit.

The acidic silica nanoparticles may have an average particle size between 1 nanometers (nm) and 100 nm, such as between 5 nm and 95 nm. In some embodiments the acidic silica nanoparticles may be between 5 nm and 50 nm, between 5 nm and 20 nm, between 20 nm and 40 nm, between 40 nm and 60 nm, between 60 nm and 80 nm, or between 80 nm and 100 nm.

The silica nanoparticles can have a greater surface area than larger silica particles (e.g., silica particles with an average particle size distribution in the micron range). As will be appreciated by those skilled in the art, a smaller particle size results in a greater surface area to volume ratio, which may allow for turning of the reactivity of the silica nanoparticles based on available surface area. The specific surface area of acidic silica nanoparticles may be between 100 square meters per gram (m²/g) and 500 m²/g, alternatively between 100 m²/g and 300 m²/g, alternatively between 100 m²/g and 200 m²/g, alternatively between 100 m²/g and 400 m²/g, and alternatively between 150 m²/g and 200 m²/g. The greater surface area of the acidic silica nanoparticles can affect the rate of gelation and the nature of the gels formed.

The acidic silica nanoparticles may have a density in solution in a range of from about 1.0 gram per milliliter (g/mL) to about 2.0 g/mL, such as from about 1.0 g/mL to about 1.8 g/mL, from about 1.0 g/mL to about 1.7 g/mL, from about 1.0 g/mL to about 1.6 g/mL, from about 1.0 g/mL to about 1.5 g/mL, from about 1.0 g/mL to about 1.4 g/mL, from about 1.05 g/mL to about 1.8 g/mL, from about 1.05 g/mL to about 1.7 g/mL, from about 1.05 g/mL to about 1.6 g/mL, from about 1.05 g/mL to about 1.5 g/mL, or from about 1.05 g/mL to about 1.4 g/mL.

An acidic nanosilica particle having the combination of particle size, specific surface area, and density may provide advantageous results including an ability to form a gelled solid, and a gelling time downhole.

In one or more embodiments, the acidic nanosilica dispersion includes a stabilizer. The acidic nanosilica particles may be stabilized by additional repulsive charges from the stabilizer. Examples of a suitable stabilizer include, but are not limited to oxy chloride, organic acids, and mineral acids. Examples of suitable organic acids include but are not limited to acetic acid, formic acid, lactic acid, citric acid, oxalic acid, uric acid, malic acid, tartaric acid, and a combination thereof. Examples of suitable mineral acids include but are not limited to hydrochloric acid, hydrofluoric acid, hydrobromic acid, hydriodic acid, boric acid, phosphoric acid, perchloric acid, sulfuric acid, nitric acid, and a combination thereof. The acidic nanosilica dispersion may include from 0.1 wt % to 15 wt % of a stabilizer.

In one or more embodiments, the acidic nanosilica dispersion further includes a cationic species. The cationic species may be a positive ion or a cationic polymer. The cationic species may act as an additional stabilizer, providing additional repulsive charges to maintain the acidic nanosilica dispersion. Suitable types of positive ions are those with high valence, including aluminum and iron ions, which have a charge of +3 or greater. Examples of salts that contribute such positive ions to the dispersion include, but are not limited to, aluminum in aluminum oxide (Al₂O₃) or aluminum sulfate (Al₂(SO₄)₃), and iron in iron (III) chloride FeCl₃ or iron (III) sulfate (Fe₂(SO₄)₃).

The acidic nanosilica dispersion may include from 0.1 wt % to 15 wt % of a cationic species salt, such as from about 0.1 wt % to about 10 wt %, from about 0.5 wt % to about 15 wt %, or from about 0.5 wt % to about 10 wt % based on the total nanosilica dispersion weight.

The acidic nanosilica dispersion may have a pH between 3 and 6. In one or more embodiments, the acidic nanosilica dispersion may have a pH between 3 and 5, or a pH between 3 and 4, when measured at room temperature. The acidic nanosilica dispersion may have a pH with a lower limit of any one of 3, 3.5, 4.0, 4.5 and 5.0, and an upper limit of any one of 4, 4.5, 5, 5.5 and 6, where any lower limit may be paired with any mathematically compatible upper limit.

The concentration of the acidic silica nanoparticles in the acidic nanosilica dispersion may be between 5 percent by weight (wt %) and 60 wt %, the balance being water. The concentration of nanosilica in the acidic nanosilica dispersion may affect the rate of gel formation, the greater the concentration of nanosilica in the acidic nanosilica dispersion the faster rate of gel formation. The concentration of the acidic silica nanoparticles in the acidic nanosilica dispersion can be between 5 wt % and 50 wt %, such as in the range from about 10 wt % to 50 wt %, from about 15 wt % to 50 wt %, from about 15 wt % to 45 wt %, from about 15 wt % to 40 wt %, from about 15 wt % to 35 wt %, from about 15 wt % to 30 wt %, from about 20 wt % to 35 wt %, from about 20 wt % to 30 wt %, from about 20 wt % to 50 wt %, or from about 30 wt % to about 50 wt % compared to the total weight of the dispersion.

The density of the acidic nanosilica dispersion may be in a range of from 1 to 5 g/mL, such as from 1 to 4.5 g/mL, from 1 to 4 g/mL, from 1 to 3.5 g/mL, from 1 to 3 g/mL, from 1 to 2.5 g/mL, from 1 to 2 g/mL, or from 1 to 1.5 g/mL.

The viscosity of the acidic nanosilica dispersion may be in a range of from 1 to 50 centipoise (cP) at room temperature (from about 20° C. to about 25° C.) and low shear rate (from about 500 reciprocal seconds (s⁻¹) to about 550 s⁻¹, or from about 500 s⁻¹ to about 520 s⁻¹), such as from 1 to 25 cP, from 1 to 20 cP, from 1 to 15 cP, from 1 to 10 cP, or from 1 to 5 cP.

Formation of a gel according to embodiments herein may be initiated by contact of the acidic silica nanoparticle dispersion with an activator. Activators useful according to embodiments herein may include a formate. The formate activator may be from a group including sodium formate, potassium formate, cesium formate, and a combination thereof.

The formate activator may be used at a weight ratio to the acidic nanosilica dispersion in a range from 0.01:1 to 1:1. The ratio of the formate activator to the acidic nanosilica dispersion may impact the gelation time. In some embodiments, the activator may be present in an amount in a range from 1 wt % to 40 wt % of the LCM; such as from a lower limit of 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, or 25 wt % to an upper limit of 20 wt %, 21 wt %, 22 wt %, 23 wt %, 24 wt %, 25 wt %, 26 wt %, 27 wt %, 28 wt %, 29 wt %, 30 wt %, 35 wt %, or 40 wt %, where any lower limit may be combined with any mathematically compatible upper limit.

One or more embodiments of the LCM composition also includes a base material additive commonly found in LCM materials. Suitable additives include one or more not limited to the following: polymers, corn stalks, rice hulls, cotton burrs, corn cobs, tree bark, animal hair, mineral fibers, citrus pulp, shredded paper, ground peanut shells, mica flakes, mica, fibrous material, cellophane, walnut shells, flaky material, plastic pieces, marble, wood, wood chips, formica, plant fibers, cottonseed hulls, ground rubber, polymeric materials, and nut hulls, among other LCM materials commonly used in the art.

A LCM including an acidic nanosilica dispersion and a formate activator may effectively and efficiently form a gel sufficient for reducing lost circulation. In one or more other embodiments, a loss control material composition includes an acidic nanosilica dispersion, a formate activator, and a viscosifier, which may be used for reducing lost circulation. In one or more other embodiments, a loss control material composition includes an acidic nanosilica dispersion and a formate activator which may be used for reducing lost circulation.

The LCM composition contains less than 5% by weight salts, according to one or more embodiments herein. In other embodiments, the LCM composition may contain less than 4% by weight salts, less than 3% by weight salts, less than 2% by weight salts, less than 1% by weight salts, or less than 0.1% by weight salts. In one or more embodiments, the LCM composition contains less than 0.1% by weight salts. Salts in the LCM composition can result in untimely conversion of the LCM composition into the solid gel loss circulation material.

Embodiments herein may be useful over a wide range of downhole conditions, including temperatures of up to 250° C., such as up to about 200° C., up to about 175° C., up to about 150° C., up to about 125° C., or up to about 100° C. Downhole pressures may be from about 50 pounds per square inch (psi) (0.345 megapascals (MPa)) to about 30,000 psi (206 MPa), such as from about 100 psi (0.689 MPa) to about 30,000 psi, from about 1,000 psi (6.90 MPa) to about 30,000 psi, from about 50 psi to about 20,000 psi (138 MPa), from about 100 psi to about 20,000 psi (68.9 MPa), from about 1,000 psi to about 20,000 psi, from about 50 psi to about 10,000 psi, from about 100 psi to about 20,000 psi, or from about 1,000 psi to about 10,000 psi. At these downhole conditions, the composition may solidify within 16 hours (gelling time) downhole. The gelling time is not limited to 16 hours and may be less, such as 14 hours or less, 12 hours or less, or 10 hours or less.

In one or more embodiments, the time to form a gelled solid (or “gelation time”) is from 6-24 hours, from 12-24 hours, from 6-12 hours, from 1-24 hours, or from 1-12 hours. The gelation time may be in a range with a lower limit of any one of 1, 2, 3, 5, 6, 7.5, 8, 9, 10, or 12 hours with an upper limit of any one of 6, 8, 10, 12, 12.5, 14, 16, 20, 22, 23, 23.5, or 24 hours, where any lower limit may be paired with any mathematically compatible upper limit.

### Method of Treating a Lost Circulation Zone

In another aspect, embodiments herein relate to a method of producing a solid gel based loss circulation material by contacting the acidic nanosilica dispersion with a chemical activator. As mentioned above, the combination of acidic nanosilica dispersion and formate activator forms a gelled solid based LCM. In one or more embodiments, the formate activator acts as an activator that promotes aggregation of acidic nanosilica particles in the nanosilica dispersion. The formation of gels using the combination of nanosilica dispersions and formate activator according to embodiments herein may decrease loss of drilling fluids in any suitable type of lost circulation zone.

In one or more embodiments, the acidic nanosilica dispersion may be introduced into the wellbore such that the acidic nanosilica dispersion contacts the lost circulation zone. Subsequently, the fromate activator may be introduced into the lost circulation zone in downhole conditions to contact the acidic nanosilica dispersion. Contacting the formate activator with the acidic nanosilica dispersion results in the formation of a gelled solid formed from the reaction of the acidic nanosilica dispersion and the formate activator, reducing the rate of lost circulation in the lost circulation zone. When the composition has multiple activators, each activator may be introduced into the wellbore separately or simultaneously with another activator. Further, the activator(s) may be introduced separately or simultaneously with the overall composition.

The addition of an activator to the acidic nanosilica dispersion results in weakened repulsive interactions between the acidic silica nanoparticles, leading to collisions of the nanoparticles in the dispersion. Collision of nanoparticles results in aggregation of nanosilica into long chain-like networks caused by formation of siloxane (Si—O—Si) bonds and subsequently results in gelling of the acidic nanosilica dispersion.

This aggregation may be controlled by an acidic nanosilica dispersion that is either premixed or not premixed prior to introduction of the LCM composition downhole. For example, acidic nanosilica dispersion and activator that is premixed may provide a quicker gelling time compared to acidic nanosilica dispersion and activator that is not premixed. In some instances, a quicker gelling time may be advantageous and in other instances a slower gelling time may be advantageous.

In other embodiments, the acidic nanosilica dispersion and the activator may be mixed and then subsequently introduced into the lost circulation zone. The mixture thus introduced to the lost circulation zone may form a gelled solid, resulting in decreased fluid loss.

In some embodiments, the gelling time (the time for which the nanosilica dispersion begins to form a gel) of the acidic nanosilica dispersion may be controlled. For example, the gelling time may be affected by the concentration of activator used. The gelling tendency of the system may be accelerated by changing the pH of the system from acidic to alkaline, where the more alkaline the system, the faster the gel formation occurs. For example, an LCM with an acidic pH (e.g., a pH of 4 or below) may have a slower gelation rate than an LCM with a more alkaline pH. In some embodiments, an LCM with an acidic pH may be increased to a pH in a range from 4 to 6 to accelerate gelation. The amount of activator used, for example, may thus depend upon the method used for introduction of the LCM into the lost circulation zone; when pre-mixed, a longer gel time may be desirable.

In other embodiments, the gelling time of the acidic nanosilica dispersion may also be affected by downhole conditions. The gelling time may be affected by higher temperatures and pressures. Possible downhole conditions have been previously described.

As described above, embodiments herein are directed toward a LCM including an acidic nanosilica dispersion and a formate activator. The LCM utilizes network structures formed from the acidic nanosilica and activator gelled material. The nanosilica gelling may advantageously be controlled by varying the relative concentration of the activator, allowing the gel to selectively form in the lost circulation zone. Further, the gelling tendency of the system can be accelerated by changing the pH of the system. Additionally, such gels formed may be used at elevated temperatures and advantageously utilizes environmentally friendly ingredients. Even further, it is theorized that use of such a LCM may be compatible with any suitable type of drilling fluid.

In one or more embodiments, the composition does not include alkaline nanosilica particles or dispersion, or a base. The inclusion of alkaline nanosilica or base would lead to an unstable LCM with one or more embodiments of the acidic nanosilica dispersion herein.

### Example

Example 1: 80 grams of acidic nanosilica dispersion was taken in a beaker. The acidic nanosilica (CS30-516 P) used in one or more embodiments was obtained from Akzo Nobel. It is an acidic nanosilica dispersion stabilized by oxy chloride. Typical properties of acidic nanosilica dispersion used in the examples are summarized in Table 1.

TABLE 1

| Specific | Surface area | | | | |
|---|---|---|---|---|---|
| surface area | (m²/g, | | | Density | Viscosity |
| (m²/g) | via BET)) | wt % SiO₂ | pH | (g/mL) | cPs) |
| 160 | 200 | 25 | 3.8 | 1.2 | 3.0 |

20 grams of sodium formate (activator) was added to the 80 grams of acidic nanosilica dispersion in a beaker. The dispersion was mixed well using a stirrer. The nanosilica dispersion along with sodium formate was subjected to static aging under pressure of 100 psi at 250° F. for 16 hours. After 16 hours of static aging, the nanosilica dispersion was converted into a solid.

Unless defined otherwise, all technical and scientific terms used have the same meaning as commonly understood by one of ordinary skill in the art to which these systems, apparatuses, methods, processes and compositions belong.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

When the word “approximately” or “about” are used, this term may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

1. A loss circulation material comprising:
an acidic nanosilica dispersion; and
a formate activator, wherein the formate activator is present in an amount in a range of 1 wt % to 40 wt % of the loss circulation material,
wherein the formate activator is selected from a group consisting of sodium formate, potassium formate, cesium formate, and combinations thereof, and
wherein the acidic nanosilica dispersion and formate activator yield a gelled solid in a time ranging from 1 to 16 hours.

2. The loss circulation material of claim 1, wherein the acidic nanosilica dispersion comprises acidic silica nanoparticles, stabilizer, and water.

3. The loss circulation material of claim 2, wherein the acidic silica nanoparticles have a SiO₂ content in a range from 5 wt % to 65 wt %.

4. The loss circulation material of claim 2, wherein the stabilizer is stabilizer is one or more selected from a group consisting of oxy chloride; an organic acid selected from acetic acid, formic acid, lactic acid, citric acid, oxalic acid, uric acid, malic acid, tartaric acid, or a combination thereof; and a mineral acid selected from hydrochloric acid, hydrofluoric acid, hydrobromic acid, hydriodic acid, boric acid, phosphoric acid, perchloric acid, sulfuric acid, nitric acid, or a combination thereof.

5. The loss circulation material of claim 2, wherein the acidic nanosilica dispersion further comprises a cationic species with a charge of +3.

6. The loss circulation material of claim 1, wherein the acidic nanosilica dispersion has a pH in a range of 3 to 6.

7. The loss circulation material of claim 1, wherein the acidic nanosilica dispersion has a surface area of 100 to 500 m²/g.

8. (canceled)

9. A method to control lost circulation in a lost circulation zone in a wellbore, comprising:
introducing an acidic nanosilica dispersion into the wellbore;
introducing a formate activator into the wellbore;
contacting the acidic nanosilica dispersion with the formate activator, thereby forming a loss circulation material composition wherein the formate activator is present in an amount in a range of 1 wt % to 40 wt % of the lost circulation material; and
forming a gelled solid from the loss circulation material in the lost circulation zone
wherein the formate activator is selected from a group consisting of sodium formate, potassium formate, cesium formate, and combinations thereof, and
wherein the gelled solid is formed in a time ranging from 1 to 16 hours.

10. The method of claim 9, wherein the acidic nanosilica dispersion comprises silica nanoparticles with a SiO₂ content in a range from 5 wt % to 65 wt %.

11. The method of claim 9, wherein the acidic nanosilica dispersion has a pH in a range of 3 to 6.

12. The method of claim 9, wherein the formate activator is from a group consisting of sodium formate, potassium formate, cesium formate, and combinations thereof.

13. The method of claim 9, wherein formation of the gelled solid occurs within 1 to 16 hours.

14. The method of claim 9, wherein the acidic nanosilica dispersion has a surface area of 100 to 500 m²/g.

15. A method of controlling lost circulation in a lost circulation zone in a wellbore, comprising:
introducing a loss circulation material comprising an acidic nanosilica dispersion and a formate activator into the wellbore, such that they contact the lost circulation zone,
wherein the formate activator is present in an amount in a range of 1 wt % to 40 wt % of the lost circulation material; and
forming a gelled solid from the loss circulation material in the lost circulation zone.

16. The method of claim 15, wherein the acidic nanosilica dispersion comprises silica nanoparticles with a SiO₂ content in a range from 5 wt % to 65 wt %.

17. The method of claim 15, wherein the acidic nanosilica dispersion has a pH in a range of 3 to 6.

18. The method of claim 15, wherein the formate activator is from a group consisting of sodium formate, potassium formate, cesium formate, and combinations thereof.

19. The method of claim 15, wherein formation of the gelled solid occurs with 1 to 16 hours.

20. The method of claim 15, wherein the acidic nanosilica dispersion has a surface area of 100 to 500 m²/g.
